(19) United States
(12) Patent Application Publication
(10) Pub. No.: US 2014/0192097 A1
(43) Pub. Date: Jul. 10, 2014

(54) DISPLAY DRIVER CIRCUIT AND METHOD OF TRANSMITTING DATA IN A DISPLAY DRIVER CIRCUIT

(71) Applicant: Samsung Electronics Co., Ltd., Suwon-si (KR)

(72) Inventors: Dong-Hoon BAEK, Seoul (KR); Jae-Youl LEE, Hwaseong-si (KR); Han-Su PAE, Seongnam-si (JP); Dong-Myung LEE, Suwon-si (KR); Sun-Ik LEE, Hwaseong-si (KR); Yong-Min CHOI, Suwon-si (KR)

(73) Assignee: Samsung Electronics Co., Ltd., Suwon-si (KR)

(21) Appl. No.: 14/151,427

(22) Filed: Jan. 9, 2014

(30) Foreign Application Priority Data
Jan. 10, 2013 (KR) 10-2013-0002758

(51) Int. Cl. G09G 3/36

(52) U.S. Cl. CPC G09G 3/3611
USPC 345/690; 345/87

(57) ABSTRACT

A display driver circuit includes a source driver and a display driver. The source driver drives source lines of a display panel, and the timing controller transmits image data to the source driver and controls the source driver such that the transmitted image data is displayed in the display panel. The timing controller randomizes the image data in a scrambling mode when the timing controller transmits data packets including pixel data field in which the image data is written.

### CROSS-REFERENCE TO RELATED APPLICATION(S)

This application claims priority under 35 USC §119 to Korean Patent Application No. 10-2013-0002758, filed on Jan. 10, 2013, in the Korean Intellectual Property Office (KIPO), the contents of which are incorporated herein in their entirety by reference.

### BACKGROUND

1. Technical Field

This disclosure generally relates to a display device, and more particularly to a display driver circuit and a method of transmitting data in a display driver circuit.

2. Description of the Related Art

For a light and low-powered user device, a flat panel display device such as a liquid crystal display (LCD) may be used instead of a cathode-ray tube (CRT). The flat panel display device may include a display panel for displaying an image, and the display panel may be formed of a plurality of pixels. The pixels may be formed at intersections of a plurality of gate lines (used to select gates of pixels) and a plurality of source lines (used to transfer color data such as gray-scale data).

An image may be displayed on the display panel by applying a control signal to a gate line and supplying color data to a source line. A display driver integrated (DDI) circuit may supply the control signal and the color data to the display panel.

When a large-sized display panel is adopted for displaying high quality image, the control signals and color data are transmitted to the display panel through long transmission lines, and thus errors due to electromagnetic interference (EMI) may occur.

### SUMMARY

Some example embodiments provide a display driver circuit capable of reducing EMI.

Some example embodiments provide a method of transmitting data in a display driver circuit capable of reducing EMI.

According to an exemplary embodiment, a display driver circuit includes a source driver and a display driver. The source driver drives source lines of a display panel, and the timing controller transmits image data to the source driver and controls the source driver such that the transmitted image data is displayed in the display panel. The timing controller randomizes the image data in a scrambling mode when the timing controller transmits data packets including pixel data field in which the image data is written.

In one embodiment, the timing controller may include a scrambler that randomizes the image data and the scrambler randomizes the image data by generating a single bit scrambling code or multi-bit scrambling codes.

The source driver may include a de-scrambler configured to de-randomize the transferred image data, wherein the de-scrambler is configured to de-randomize the transmitted image data by receiving a scrambling mode signal and a de-scrambler enable signal that enables the de-scrambler from the timing controller. The scrambling mode signal may indicate whether the image data is randomized using the single bit scrambling code or the multi-bit scrambling codes.

The data packet further includes a configuration field for controlling the source driver, and the de-scrambler enable signal and the scrambling mode signal are written in the configuration field which are transmitted from the timing controller to the source driver.

In one embodiment, the timing controller may write a random data pattern in a horizontal blank field and may transmit the horizontal blank field to the source driver when the timing controller transmits the horizontal blank field which is assigned for the source driver to have a time to drive the display panel. The random data pattern may be generated by applying a scrambling code to a clock pattern

The timing controller may include a pattern generator configured to generate the clock pattern; and a scrambler configured to generate the random data pattern based on the clock pattern.

The source driver may receive a horizontal blank field control signal to de-randomize the random data pattern, and the horizontal blank field control signal may indicate that the scrambling code is applied to a data pattern written in the horizontal blank field.

The data packet may further include a configuration field for controlling the source driver and the horizontal blank field control signal is written in the configuration field which are transferred from the timing controller to the source driver.

The display driver circuit may further include an additional source driver configured to drive additional source lines of a display panel. The timing controller is configured to randomize image data for the additional source driver and send the randomized image data over a separate channel to the second source driver.

According to an exemplary embodiment, a method of transferring data of a display driver circuit, includes transmitting configuration field from a timing controller to a source driver, configuration data for controlling the source driver being written in the configuration field; transmitting pixel data field in which image data is written from the timing controller to the source driver; transmitting a waiting field which is assigned for the source driver to have a first time to receive and to store the image data from the timing controller; and transmitting a horizontal blank field which is assigned for the source driver to drive a display panel based on the image data from the timing controller to the source driver. The timing controller randomizes the image data in a scrambling mode and transmits the scrambled image data to the source driver.

In one embodiment, the method may further include de-randomizing the scrambled image data in the source driver.

In one embodiment, the method further includes randomizing the image data by generating a single-bit scrambling code or a multi-bit scrambling code based on the state of the image data.

In one embodiment, the timing controller inserts a scrambling mode signal in the configuration field and transmits the configuration field to the source driver and the source driver de-randomizes the transmitted image data in response to the scrambling mode signal. The scrambling mode signal indicates whether the image data is randomized to the single bit scrambling code or the multi-bit scrambling codes.

In one embodiment, the timing controller may write a random data pattern that a scrambling code is applied to a clock pattern in a horizontal blank field and transmits the horizontal blank field to the source driver when the timing controller transmits the horizontal blank field which is assigned for the source driver go have a time to drive the display panel.

The random data pattern may be one of a plurality of random data patterns that are generated by applying the scrambling to the clock pattern.

The timing controller may insert a horizontal blank field control signal in the configuration field and may transmit the configuration field to the source driver. The horizontal blank field control signal indicates that the scrambling code is applied to data pattern written in the horizontal blank field.

In one embodiment, a display driver circuit includes a timing controller configured to transmit first scrambled image data to a first channel, and to transmit second scrambled image data to a second channel; a plurality of source drivers coupled to the timing controller and configured to receive scrambled image data from the timing controller via a respective channel; a first source driver of the plurality of source drivers, the first source driver coupled to the first channel and configured to receive the first scrambled image data and de-scramble the image data; and a second source driver of the plurality of source drivers, the second source driver coupled to the second channel and configured to receive the second scrambled image data and de-scramble the image data.

Accordingly, the image data is randomized in the scrambling mode, thereby reducing EMI in the channels.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display device including a display driver circuit according to an exemplary embodiment.

FIG. 2 illustrates an equivalent circuit diagram of a pixel of a display panel in FIG. 1, according to an exemplary embodiment.

FIG. 3 is a state diagram illustrating an example of operating modes of a display device illustrated in FIG. 1, according to an exemplary embodiment.

FIG. 4 is a block diagram illustrating the timing controller in FIG. 1 according to an exemplary embodiment.

FIG. 5 is a block diagram illustrating one of the source drivers in FIG. 1 according to an exemplary embodiment.

FIG. 6 is a diagram illustrating display data transferred in a display device of FIG. 1, according to an exemplary embodiment.

FIG. 7 is a diagram illustrating a data packet transmitted during a data transfer period, according to an exemplary embodiment.

FIGS. 8 through 10 respectively illustrate data packets according to exemplary embodiments.

FIGS. 11 and 12 illustrate configuration and operation of a first scrambler included in the scrambling unit in FIG. 4, according to exemplary embodiments.

FIG. 13 is a block diagram illustrating a second scrambler included in the scrambling unit in FIG. 4, according to exemplary embodiments.

FIGS. 14 and 15 illustrate configuration and operation of the de-scrambler in FIG. 5, according to exemplary embodiments.

FIG. 16 illustrates the clock pattern generated in the pattern generator in FIG. 4 and the random data patterns generated in the second scrambler in FIG. 13, according to exemplary embodiments.

FIG. 17 is a state diagram illustrating sequence of the random data patterns generated in the second scrambler in FIG. 13, according to exemplary embodiments.

FIG. 18 illustrates an EMI level when the horizontal blank period including the clock pattern and the random data patterns is transmitted to the source driver, according to exemplary embodiments.

FIG. 19 is a timing diagram illustrating control signals in the data transfer period according to an exemplary embodiment.

FIG. 20 is a flow chart illustrating a method of transmitting data in a display device of FIG. 1, according to exemplary embodiments.

FIG. 21 is a flow chart illustrating a step of transmitting data packet in FIG. 20 according to an exemplary embodiment.

FIG. 22 is a display system including the display device of FIG. 1 according to an exemplary embodiment.

FIG. 23 is a block diagram illustrating an electronic device including the display device of FIG. 1 according to an exemplary embodiment.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms unless indicated otherwise. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “on,” or “connected” or “coupled” to another element, it can be directly on, directly connected to, or directly coupled to the other element or intervening elements may be present. In contrast, when an element is referred to as being “directly on,” “directly connected,” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

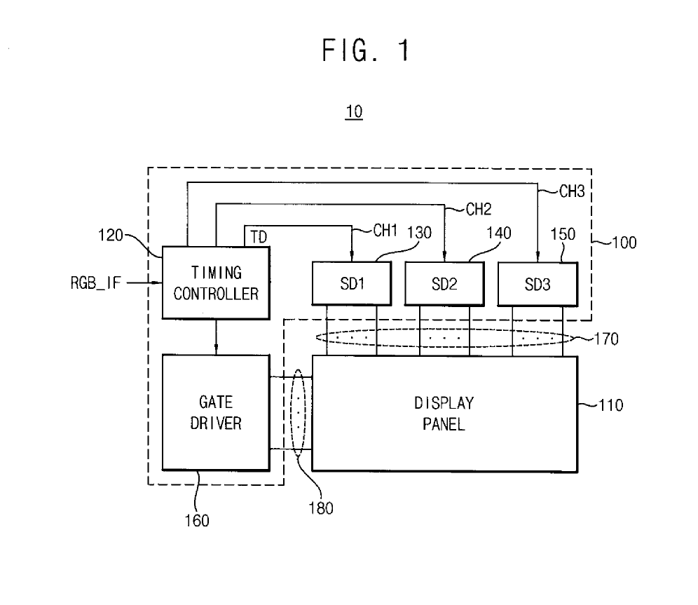

FIG. 1 is a block diagram illustrating a display device including a display driver circuit according to an exemplary embodiment.

Referring to FIG. 1, a display device 10 includes a display driver circuit 100 and a display panel 110. The display driver circuit 100 includes a timing controller 120, a plurality of source drivers 130, 140 and 150 and a gate driver 160.

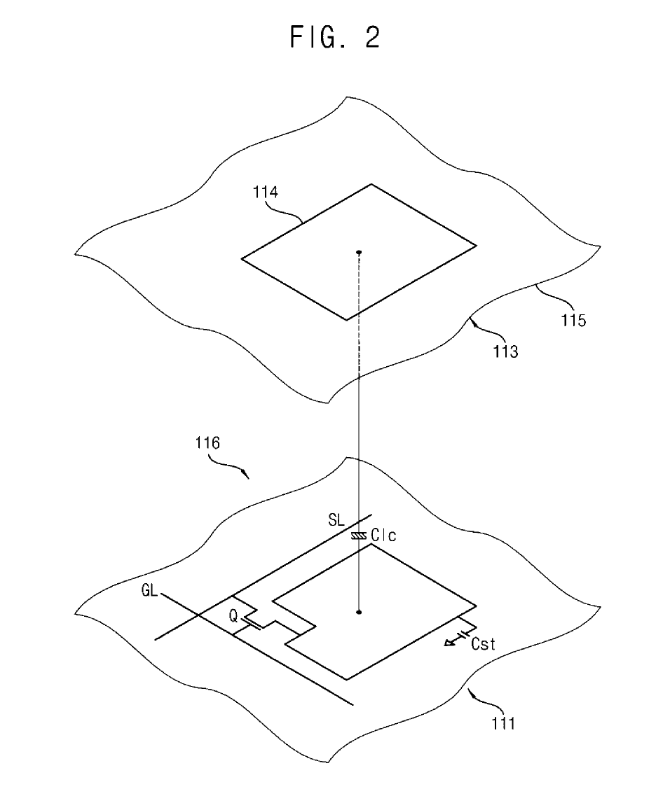

The display panel 110 may include a plurality of pixels for displaying an image. The pixels may be formed at intersections of gate lines 180 and source lines 170 respectively. Each of the pixels may include a switching element connected with a gate line and a source line, a liquid crystal capacitor connected with the switching element, and a storage capacitor (not shown). The pixels will be more fully described with reference to FIG. 2, below.

The timing controller 120 may receive a RGB interface (I/F) signal RGB_IF from an external graphic processor. The RGB I/F signals RGB_IF may include control signals and image data. For example, the control signals included in the RGB I/F signals RGB_IF may include a vertical sync signal VSYNC, a horizontal sync signal HSYNC, and a data enable signal DE. The timing controller 120 may provide the gate driver 160 and the source drivers 130, 140 and 150 with control signals for driving the display panel based upon the input control signals. Thus, the timing controller 120 may control an overall operation of the display driver circuit 100.

Herein, the vertical sync signal VSYNC included in the RGB I/F signals RGB_IF may indicate a time taken to display one frame on the display panel 110. The horizontal sync signal HSYNC may indicate a time taken to drive pixels connected with one of the gate lines 180. Accordingly, the horizontal sync signal HSYNC may be formed of pulses corresponding to pixels connected with one gate line, respectively. The data enable signal DE may indicate a time taken to provide image data to pixels of the display panel 110. The image data may be stored in a memory device (not shown) according to the control of the timing controller 120, and then may be provided to the source drivers 130, 140 and 150.

The gate driver 160 may drive the gate lines 180 under the control of the timing controller 120. For example, in response to a control signal provided from the timing controller 120, the gate driver 160 may control the gate lines 180 so as to be activated sequentially. The source drivers 130, 140 and 150 may drive lines 170 under the control of the timing controller 120. For example, in response to a control signal provided from the timing controller 120, the source drivers 130, 140 and 150 may drive the source lines 170 with image data provided from the memory device.

A control signal and image data may be provided as display data TD to the source drivers 130, 140 and 150 via channels CH1, CH2, and CH3 from the timing controller 120. Lengths of the channels CH1, CH2, and CH3 may differ according to a size of the display panel 110. Thus, the larger the display panel, the longer the channel lengths. As channel lengths become longer, the control signal and image data provided to the source drivers 130, 140 and 150 may become more erroneous due to signal delay or electromagnetic interference (EMI).

The display driver circuit 100 according to an example embodiment may be configured to randomize (scramble) the image data to transmit randomized image data to the source drivers 130, 140 and 150 via the channels CH1, CH2, and CH3 respectively when the timing controller 120 transmits image data to the source drivers 130, 140 and 150 for preventing EMI from increasing due to regular data patterns.

FIG. 2 illustrates an equivalent circuit diagram of a pixel of a display panel in FIG. 1.

Referring to FIG. 2, a display panel may include a lower display plate 111, an upper display plate 113, and a liquid crystal layer 116 interposed between the lower display plate 111 and the upper display plate 113. The lower display plate 111 may be disposed to be opposite to the upper display plate 113.

Each pixel may include a switching element Q connected with a gate line GL and a source line SL, a liquid crystal capacitor Clc connected with the switching element Q, and a storage capacitor Cst. In another implementation, the storage capacitor Cst may be omitted.

The switching element Q may be, e.g., a tri-terminal element such as a thin film transistor provided at the lower display plate 111. A control terminal of the switching element Q may be connected with the gate line GL transferring a gate signal (or, a scan signal), an input terminal thereof may be connected with the source line SL, and an output terminal thereof may be connected with the liquid crystal capacitor Clc and the storage capacitor Cst.

The liquid crystal capacitor Clc may have a pixel electrode 112 of the lower display plate 111 and a common electrode 115 of the upper display plate 113 as its two terminals. The liquid crystal layer 116 may function as a dielectric material between the electrodes 112 and 115. The pixel electrode 112 may be connected with the switching element Q. In certain embodiments, the common electrode 115 may be formed on an entire surface of the upper display plate 113 and may be supplied with a common voltage. The storage capacitor Cst (serving an auxiliary role of the liquid crystal capacitor Clc) may be formed by overlapping a signal line (not shown) provided at the lower display plate 111 and the pixel electrode 112, with an insulating material interposed between the lower display plate 111 and the pixel electrode 112. The signal line may be biased by a voltage such as the common voltage.

The display panel 110 may display colors in a space division manner, a time division manner, etc. With the space division manner, each pixel may distinctly display one of primary colors. With the time division manner, each pixel may display primary colors in turn. Thus, each pixel may display a required color by a spatial or temporal sum of primary colors, e.g., a red, a green, and a blue.

In the example pixel in FIG. 2, space division may be used. There is exemplarily shown the case where a color filter 114 indicating one of the primary colors is formed at an area of the upper display plate 113 corresponding to the pixel electrode 112. In other examples (not shown), the color filter 114 may be formed over or below the pixel electrode 112 of the lower display plate 111. At least one polarizer may be attached on an outer surface of the display panel 110 to polarize a light.

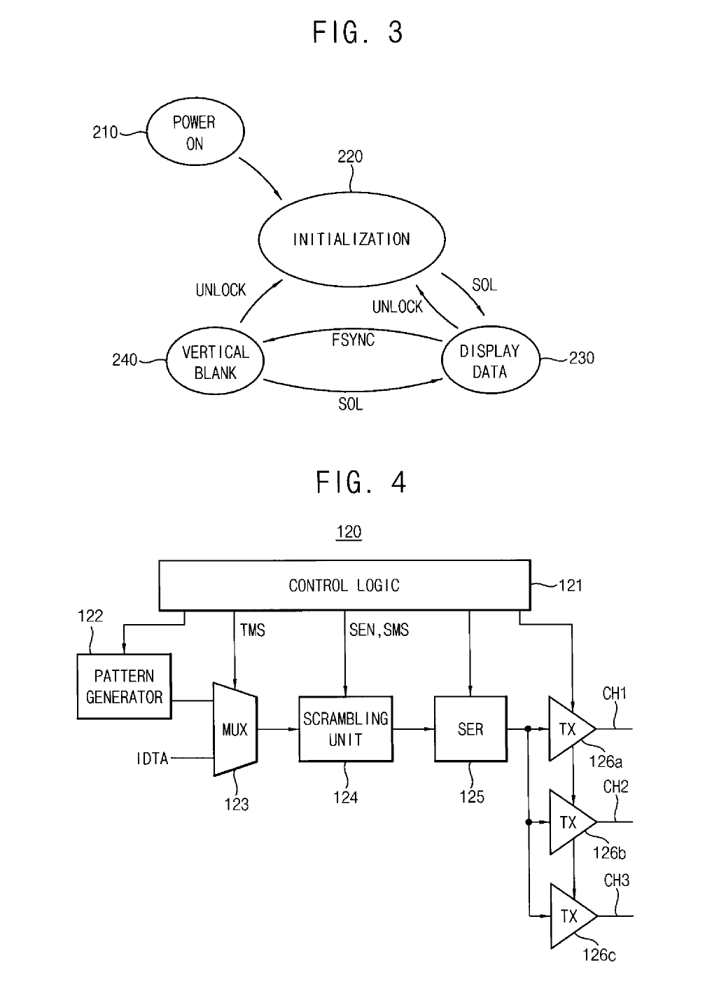

FIG. 3 is a state diagram illustrating an example of operating modes of a display device illustrated in FIG. 1, according to an exemplary embodiment.

Referring to FIGS. 1 and 3, if a display device 10 is powered on 210, the display device 100 operates in an initialization mode 220. The display device 10 operates in the initialization mode 220 during an initialization period. The initialization mode 220 may include an initial training mode. In the initial training mode, the timing controller 120 may transmit clock training signals to the source drivers 130, 140 and 150 such that the clock recovery unit becomes locked.

After the source drivers 130, 140 and 140 become locked, the display device 10 operates in a display data mode 230. The timing controller 120 may inform the source drivers 130, 140 and 150 of a start of the display data mode 230 by transmitting data including a line start field SOL to the source drivers 130, 140 and 150. The display device 10 may operate in the display data mode 230 during a data transfer period of an image frame. In the display data mode 230, the timing controller 120 may transfer data packets respectively corresponding to lines of the image frame to the source drivers 130, 140 and 150.

In one embodiment, after image data of an image frame are transferred, the display device 10 operates in a vertical training mode until image data of a next image frame are transferred. The timing controller 120 may inform the source drivers 130, 140 and 150 of an end of the display data mode 230 by transmitting data including a frame synchronization signal FSYNC to the source drivers 130, 140 and 150. The display device 10 may operate in a vertical training mode during the vertical blank mode 240. In the vertical blank mode 240, the timing controller 120 may transmit a modulated clock signal to the source drivers 130, 140 and 150.

The display data mode 230 and the vertical blank mode 240 may be performed per image frame. The display data mode 230 and the vertical blank mode 240 may be repeatedly performed until the display device 10 is powered off or until the source drivers 130, 140 and 150 are unlocked such that they become out of phase (e.g., by a soft fail). When an operating mode of the display device 10 changes from the vertical blank mode 240 to the display data mode 230, the timing controller 120 may transfer the data including the line start field SOL to the source drivers 130, 140 and 150. When the operating mode of the display device 10 changes from the display data mode 230 to the vertical blank mode 240, the timing controller 120 may transfer the data including the frame synchronization signal F SYNC to the source drivers 130, 140 and 150.

If the source drivers 130, 140 and 150 are unlocked (e.g., by a soft fail) while the display data mode 230 or the vertical blank mode 240 is performed, the display device 10 may operate again in the initialization mode 220. In the initial training mode of the initialization mode 220, the timing controller 120 may transmit the clock training signal to the source drivers 130, 140 and 150 and the clock recovery unit becomes locked based on the clock training signal. In the initial training mode of the initialization mode 220, the source drivers 130, 140 and 150 may re-initialize the setting data that was changed by the soft fail.

FIG. 4 is a block diagram illustrating the timing controller in FIG. 1 according to an exemplary embodiment.

Referring to FIG. 4, the timing controller 120 may include control logic 121, a pattern generator 122, a multiplexer (MUX) 123, a scrambling unit 134, a serializer (SER) 125 and a transmitters (TX) 126a, 126b and 126c that are connected to the respective source drivers 130, 140 and 150 via the respective channels CH1, CH2 and CH3.

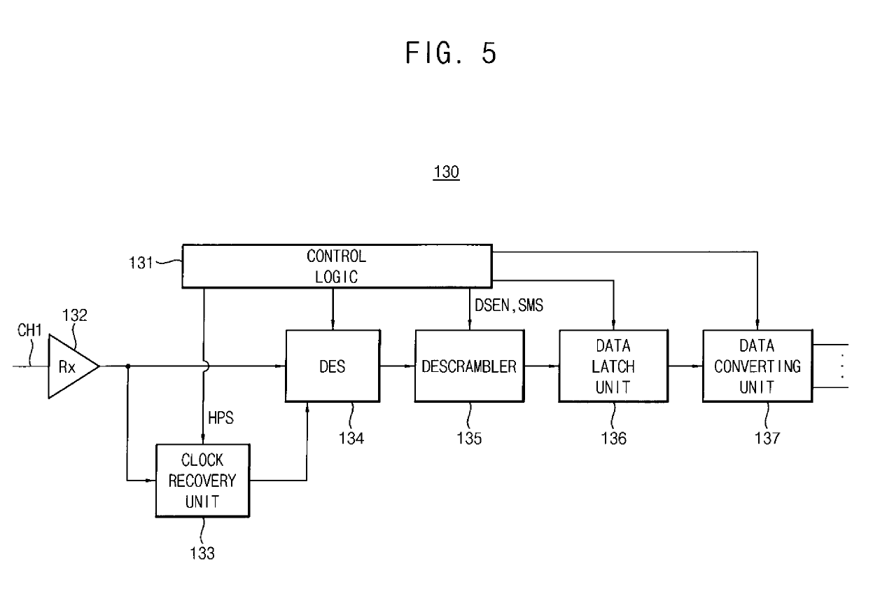

FIG. 5 is a block diagram illustrating one of the source drivers in FIG. 1 according to an exemplary embodiment.

Referring to FIG. 5, the source driver 130 may include control logic 131, a receiver 132, a clock recovery unit 133, a deserializer 134, a de-scrambler 135, a data latch unit 136 and a data converting unit 137. In FIG. 5, there is illustrated the source driver 130 of the source drivers 130, 140 and 150 for the sake of simplicity.

Hereinafter, there will be a description of operation between the timing controller 120 and the source driver 130 in the display device 10 of FIG. 1 with reference to FIGS. 4 and 5.

Generally, a digital signal transferred via a channel CH1 may be affected by the EMI according to a data pattern. However, according to one embodiment, data transmitted via the channel CH1 may be randomized (or, scrambled) so as not to be affected by the EMI. Thus, the timing controller 120 may randomize data to be provided to the source driver 130 via the scrambling unit 124, and may transmit the randomized data to the source driver 130. The source driver 130 may de-randomize the randomized data via the de-scrambler 135.

In one embodiment, the pattern generator 122 generates an irregular clock pattern to be included (inserted) in horizontal blank field (HBF) in each data packet corresponding to each line of an image frame under the control of the control logic 131.

The multiplexer 123 selects one of the clock pattern and image data IDTA to be provided to the scrambling unit 124 in response to a transmission mode signal TMS from the control logic 121. For example, the multiplexer 123 selects the image data IDTA to be provided to the scrambling unit 124 in response to the transmission mode signal TMS when a pixel data field in which the image data is written is transmitted to the source driver 130 during the data transfer period. In one embodiment, the scrambling unit 124 generates a single-bit scrambling code to be used for all bits of the data (e.g., the same scrambling bit, such as a 1-bit code, could be used for all data bits to be scrambled), or a multi-bit scrambling code (e.g., a code that includes a plurality of scrambling bits, wherein each scrambling bit can be used for a respective data bit or set of data bits to be scrambled), according to a state of the image data IDTA, to randomize the image data IDTA in response to a scrambler enable signal SEN and a scrambling mode signal SMS from the control logic 121. Here, the state of the image data IDTA is associated with data transition of the image data IDTA. For example, when data transition in the image data IDTA is small, the multi-bit scrambling code may be used. For example, when data transition in the image data IDTA is large, the single-bit scrambling code may be used. The scrambling mode signal SMS has a logic level according to the state of the image data IDTA. When the scrambling mode signal SMS has a first logic level, the scrambling unit 124 generates the multi-bit scrambling code to randomize each bit of the image data IDTA. When the scrambling mode signal SMS has a second logic level, the scrambling unit 124 generates the single-bit scrambling code to randomize each bit of the image data IDTA. The randomized data is serialized in the serializer 125 and the transmitter 126 transmits the serialized data to the source driver 130.

In one embodiment, the multiplexer 123 selects a clock pattern to be provided to the scrambling unit 124 in response to the transmission mode signal TMS when the horizontal blank field control is transmitted to the source driver 130 during the data transfer period. The scrambling unit 124 applies the scrambling code to the clock pattern to generate a random data pattern to the serializer 125. The random data pattern is serialized in the serializer 125 and the transmitter 126 transmits the serialized data to the source driver 130.

The receiver 132 provides the clock recovery unit 133 with the serialized data transmitted via the channel CH1. The clock recovery unit 133 generates a recovered clock signal from the serialized data and may generate a multi-phased clock signal based on the recovered clock signal. The clock recovery unit 133 may provide the recovered clock signal and the multi-phased clock signal to the deserializer 134.

The deserializer 134 may deserialize the serialized data based on the multi-phased clock signal. The deserializer 134 provides deserialized digital data to the de-scrambler 135. The de-scrambler 135 may de-randomize the deserialized digital data to recover the image data based on a de-scrambler enable signal DSEN and the scrambling mode signal SMS from the control logic 131. The de-scrambler enable signal DSEN and the scrambling mode signal SMS are transmitted to the control logic 131 from the timing controller 120 after the de-scrambler enable signal DSEN and the scrambling mode signal SMS are written in the configuration field during the data transfer period. When the scrambling mode signal SMS has a first logic level, the de-scrambler 135 generates the multi-bit scrambling codes to de-randomize each bit of the image data IDTA. When the scrambling mode signal SMS has a second logic level, the de-scrambler 135 generates the single bit scrambling code to de-randomize each bit of the image data IDTA. The recovered image data is provided to the data latch unit 136.

The data latch unit 136 may include a shift register. The data latch unit 136 may store the digital data associated with image data while shifting the digital data associated with image data. In one embodiment, when the data latch unit 136 stores digital data corresponding to one row of pixels included in the display panel 110, the data latch unit 136 provides the stored digital data to the data converting unit 137. The data converting unit 137 then generates analog voltages by selecting grey voltages based on the digital data from the data latch unit 136 and provides the analog voltages to the display panel 110 via a source line SL.

In one embodiment, when the random data pattern written in the horizontal blank field control is provided to the clock recovery unit 133 by the receiver 132, the clock recovery unit 133 de-randomizes the random data pattern and recovers the clock pattern in response to a horizontal blank field control signal HPS. The clock recovery unit 133 may perform clock training based on the clock pattern while the data converting unit 137 generates analog voltages by selecting grey voltages based on the digital data from the data latch unit 136 and provides the analog voltages to the display panel 110 via the source line SL.

Note that only one source driver (130) is described in detail above. However, each of the source drivers 130, 140, and 150 may include the same components as the source driver 130.

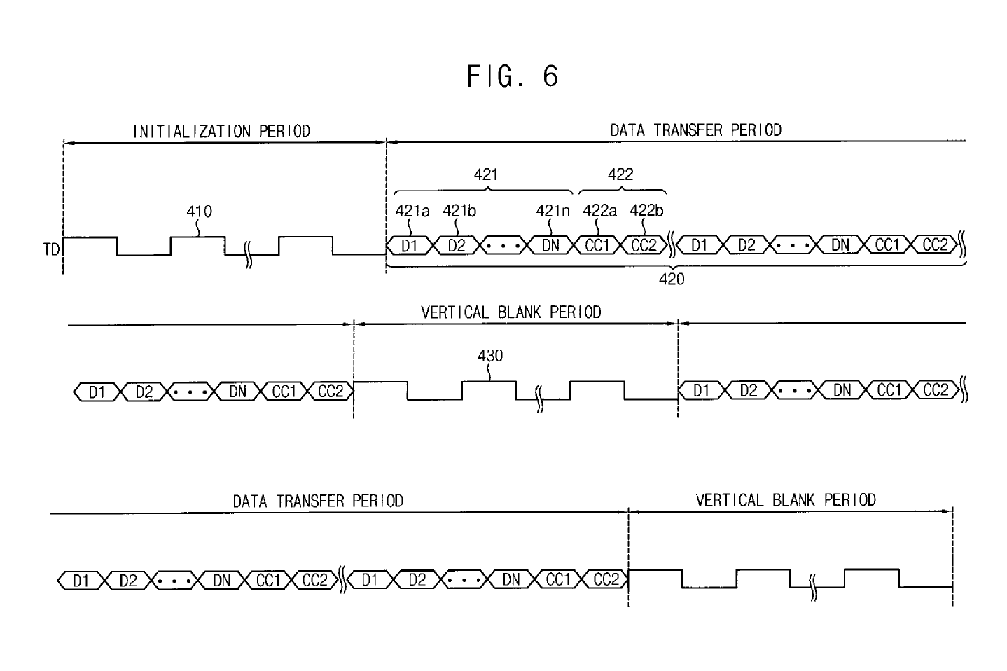

FIG. 6 is a diagram illustrating display data transferred in a display device of FIG. 1, according to an exemplary embodiment.

Referring to FIGS. 1 and 6, the timing controller 120 may transmit a clock training signal 410 to source drivers 130, 140 and 150 during the initialization period. The timing controller 120 may transfer data respectively corresponding to lines of an image frame to the source drivers 130, 140 and 150 in the data transfer period. A data 420 may include a plurality of data bits 421 and a clock code 422 periodically inserted into the data bits 421. The clock code 422 may be appended per N data bits 421a, 421b and 421n, where N is an integer more than 1. In some embodiments, as illustrated in FIG. 6, the clock code 422 may have two bits including a first bit 422a and a second bit 422b. In other embodiments, the clock code 422 may have one bit. After the data in the image frame are transferred, the timing controller 120 may transmit a modulated clock signal 430 to the source drivers 130, 140 and 150 in a vertical blank period. The modulated clock signal 430 may be generated by adjusting at least one of a rising edge or a falling edge of the clock training signal. After the vertical blank period, data for a next image frame may be transferred in a next display data mode. The data transfer period and the vertical blank period may be repeated.

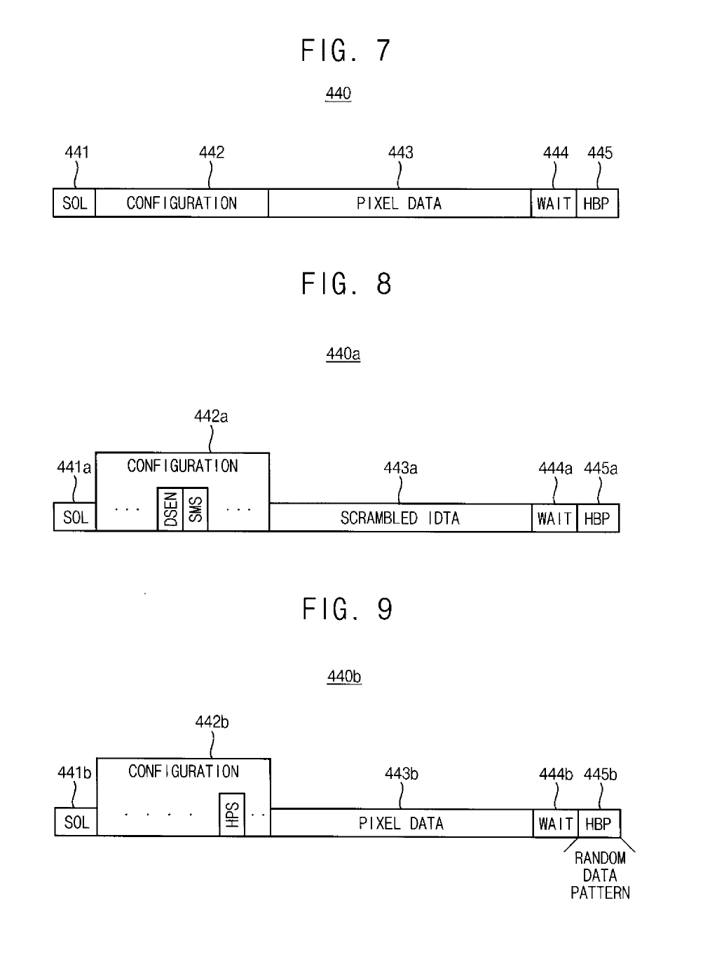

FIG. 7 is a diagram illustrating a data packet transmitted during a data transfer period, according to an exemplary embodiment.

Referring to FIG. 7, a data packet 440 transferred during the data transfer period includes a line start field 441, a configuration field 442, a pixel data field 443, a wait field 444 and a horizontal blank field 445.

The line start field 441 indicates a start of each line of an image frame. A source driver may operate an internal counter in response to the line start field 441, and may identify the configuration field 442, the pixel data field 443 and the wait field 444 based on a counting result of the internal counter. The line start field 441 may include a clock code having a specific edge or pattern to be distinguished from the horizontal blank field 445 of a previous line or from a vertical blank period of a previous image frame.

The configuration field 442 may include configuration data for controlling the source driver. Since the configuration data are written in the configuration field 442, a display device 100 of FIG. 1 may not require a line for transmitting a control signal. When a data corresponding to a last line of an image frame is transferred, the configuration data written in the configuration field 442 of the data may include a frame synchronization signal. The source driver may know that a vertical training mode is to be started by receiving the frame synchronization signal written in the configuration field 442. The configuration data may further include driver setting values, such as a bias value, equalization value, termination resistor value of the receiver, etc., for certain parts of the source driver. In some embodiments, the configuration data may further include a configuration update bit that indicates whether the configuration data is updated. For example, the source driver may not process the configuration data written in the configuration field 442 if the configuration update bit has a logic low level, and may change the driver setting values based on the configuration data if the configuration update bit has a logic high level. In addition, the configuration data may further include the de-scrambler enable signal DSEN indicating whether the image data is scrambled, the scrambling mode signal SMS indicating whether the image data is randomized using a single-bit scrambling code or multi-bit scrambling codes and the horizontal blank field control signal HPS indicating whether the scrambling code is applied to the data pattern written in the horizontal blank field.

The pixel data field 443 includes image data. The source driver may receive the image data written in the pixel data field 443, and may drive the display panel to display an image based on the image data. The wait field 444 is assigned for the source driver to have an enough time to receive and to store the image data.

The horizontal blank field 445 is assigned for the source driver to have enough time to drive the display panel based on the image data. For example, the horizontal blank field 445 may have a bit length corresponding to a time when the image data stored in a data latch unit are converted in analog voltages and are applied to the display panel. The horizontal blank field 445 may have an edge of a predetermined direction or may have a clock code of a predetermined pattern to be distinguished from the line start field 441.

FIGS. 8 through 10 respectively illustrate data packets according to exemplary embodiments.

Referring to FIG. 8, a data packet 440a transmitted in the data transfer period includes a line start field 441a, a configuration field 442a, a pixel data field 443a, a wait field 444a and a horizontal blank field 445a.

The configuration field 440a may include the de-scrambler enable signal DSEN and the scrambling mode signal SMS because the pixel data field 443a includes scrambled data that are randomized using the single bit or multi-bit scrambling codes based on the state of the image data IDTA in the scrambling unit 124.

Referring to FIG. 9, a data packet 440b transmitted in the data transfer period includes a line start field 441b, a configuration field 442b, a pixel data field 443b, a wait field 444b and a horizontal blank field 445b.

The configuration field 440b may include the horizontal blank field control signal HPS because the horizontal blank field 445a includes the random data pattern to which the scrambling code is applied.

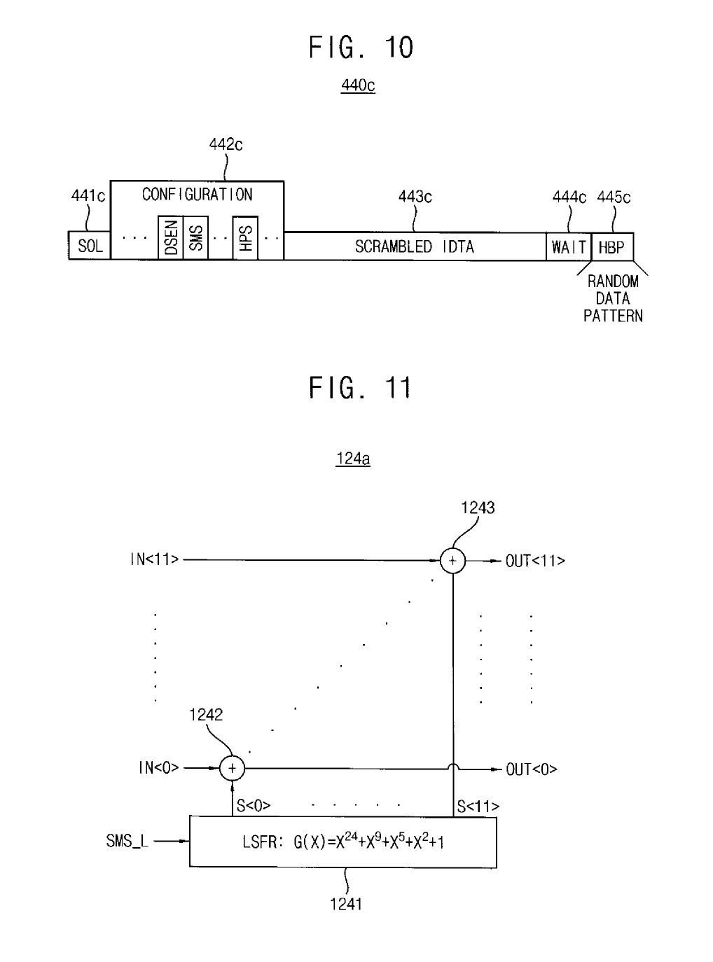

Referring to FIG. 10, a data packet 440c transmitted in the data transfer period includes a line start field 441c, a configuration field 442c, a pixel data field 443c, a wait field 444c and a horizontal blank field 445c.

The configuration field 442c may include the de-scrambler enable signal DSEN, the scrambling mode signal SMS and the horizontal blank field control signal HPS because the pixel data field 443c includes scrambled data that are randomized using a single-bit scrambling code or a multi-bit scrambling code based on the state of the image data IDTA in the scrambling unit 124 and the horizontal blank period 445a includes the random data pattern to which the scrambling code is applied.

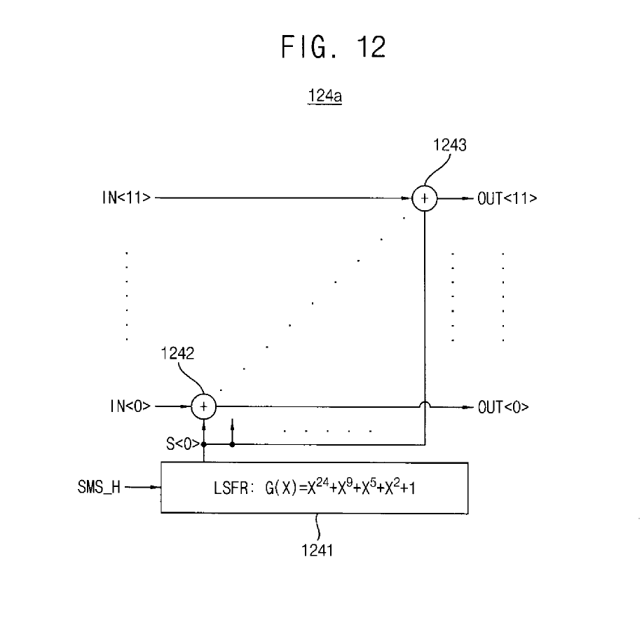

FIGS. 11 and 12 illustrate configuration and operation of a first scrambler included in the scrambling unit in FIG. 4, according to one exemplary embodiments.

Referring to FIGS. 11 and 12, a first scrambler 124a may include a scrambling code generator 1241 and XOR gates 1242 and 1243.

In the embodiments shown in FIGS. 11 and 12, the scrambling code generator 1241 may be implemented with a linear feedback shift register (LFSR) and may generate a multi-bit scrambling code including a plurality of scrambling bits S<0>˜S<11> (shown in FIG. 11) or a single-bit scrambling code including a single scrambling bit S<0> (shown in FIG. 12) in response to the scrambling mode signal SMS. For example, when the scrambling mode signal SMS is a first logic level (SMS_L), the scrambling code generator 1241 generates the multi-bit scrambling code S<0>˜S<11>. Each of the XOR gates 1242 and 1243 performs XOR operation on each bit of the image data IN<0>˜IN<11> and each bit of the scrambling code S<0>˜S<11> to generate the randomized data OUT<0>˜OUT<11>. For example, when the scrambling mode signal SMS is a second logic level (SMS_H), the scrambling code generator 1241 generates the single-bit scrambling code S<0>. Each of the XOR gates 1242 and 1243 performs XOR operation on each bit of the image data IN<0>˜IN<11> and the scrambling code S<0> to generate the randomized data OUT<0˜OUT<11>.

In other embodiments, the scrambling codes may be generated with respect to data intervals according to the state of the image data IDTA. In addition, the scrambling code generator 1241 may be implemented with a PN sequence generator and a CRC generator.

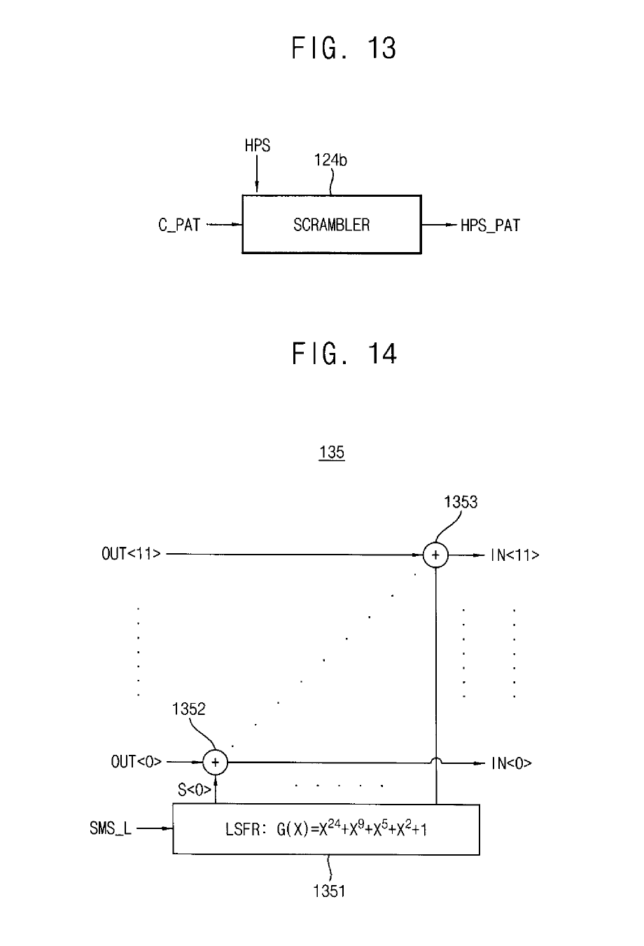

FIG. 13 is a block diagram illustrating a second scrambler included in the scrambling unit in FIG. 4, according to one exemplary embodiment.

Referring to FIG. 13, a second scrambler 124b applies scrambling codes to a clock pattern C_PAT from the pattern generator 122 to randomly generate random data patterns HPS_PAT to be written in the horizontal blank period 445, which are different from each other, in response to the HPS control signal HPS. The random data patterns HPS_PAT are recovered to the clock pattern C_PAT in the clock recovery unit 133 and the clock recovery unit 133 may perform clock training based on the clock pattern while the data converting unit 137 generates analog voltages by selecting grey voltages based on the digital data from the data latch unit 136 and provides the analog voltages to the display panel 110 via the source line SL.

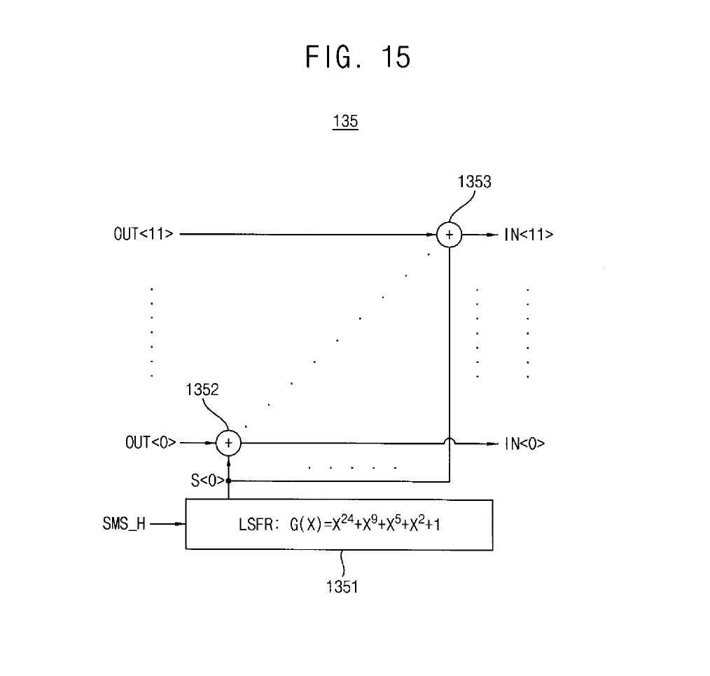

FIGS. 14 and 15 illustrate an exemplary configuration and operation of the de-scrambler in FIG. 5.

Referring to FIGS. 14 and 15, the de-scrambler 135 may include a scrambling code generator 1351 and XOR gates 1352 and 1353.

The scrambling code generator 1351 may be implemented with a linear feedback shift register (LFSR) and may generate a multi-bit scrambling code S<0>˜S<11> or a single bit scrambling code S<0> in response to the scrambling mode signal SMS. For example, when the scrambling mode signal SMS is a first logic level (SMS_L), the scrambling code generator 1351 generates the multi-bit scrambling code S<0>˜S<11>. Each of the XOR gates 1352 and 1353 performs XOR operation on each bit of randomized data OUT<0>˜OUT<11> and each bit of the scrambling codes S<0>˜S<11> to generate the image data IN<0>˜IN<11>. For example, when the scrambling mode signal SMS is a second logic level (SMS_H), the scrambling code generator 1351 generates the single-bit scrambling code S<0>. Each of the XOR gates 1352 and 1353 performs XOR operation on each bit of the image data OUT<0>˜OUT<11> and the scrambling code S<0> to generate the randomized data IN<0>˜IN<11>.

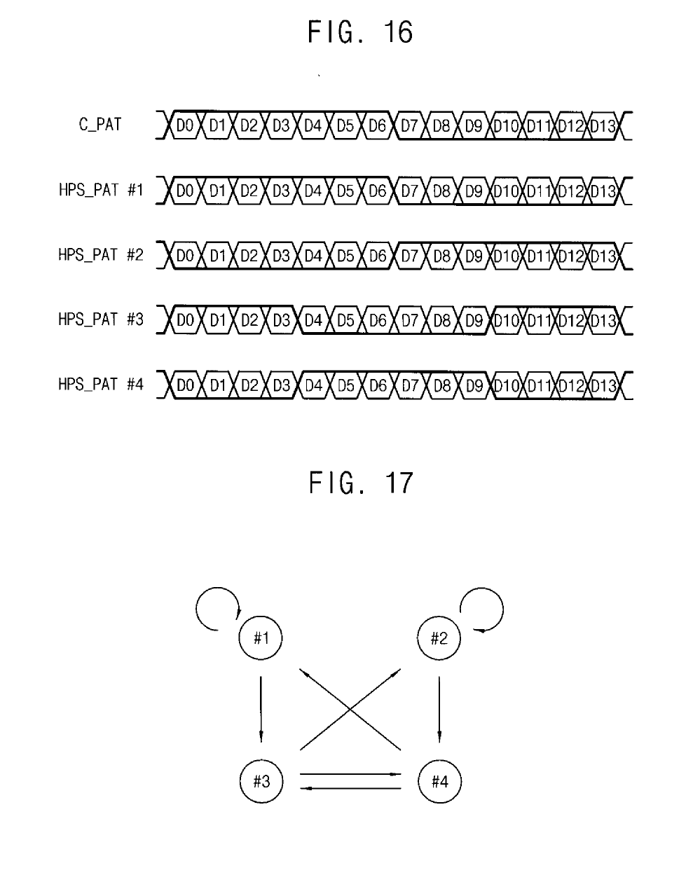

FIG. 16 illustrates the clock pattern generated in the pattern generator in FIG. 4 and the random data patterns generated in the second scrambler in FIG. 13, according to one exemplary embodiment.

FIG. 17 is a state diagram illustrating sequence of the random data patterns generated in the second scrambler in FIG. 13, according to one embodiment.

Referring to FIGS. 16 and 17, the second scrambler 124b receives the clock pattern C_PAT, scrambles the clock pattern C_PAT and generates the random data patterns HPS_PAT#1, HPS_PAT#2, HPS_PAT#3 and HPS_PAT#4. The generated random data patterns HPS_PAT#1, HPS_PAT#2, HPS_PAT#3 and HPS_PAT#4 are written in the horizontal blank period according to a sequence of the state diagram in FIG. 17 and may be transmitted to the source driver 130. That is, the generated random data patterns HPS_PAT#1, HPS_PAT#2, HPS_PAT#3 and HPS_PAT#4 are randomly written in the horizontal blank period according to a sequence of the state diagram in FIG. 17. Therefore, EMI may be reduced due to irregularity of the transmitted random data pattern period according to a sequence of the state diagram in FIG. 17.

FIG. 18 illustrates an EMI level when the horizontal blank period including the clock pattern and the random data patterns is transmitted to the source driver, according to one embodiment.

Referring to FIG. 18, it is noted that the EMI level in a first case when the horizontal blank period 445 including the clock pattern C_PAT having a regular pattern is transmitted to the source driver 130 is higher than the EMI level in a second case when the horizontal blank period 445 including random data patterns HPS_PAT#1, HPS_PAT#2, HPS_PAT#3 and HPS_PAT#4 having an irregular pattern is transmitted to the source driver 130.

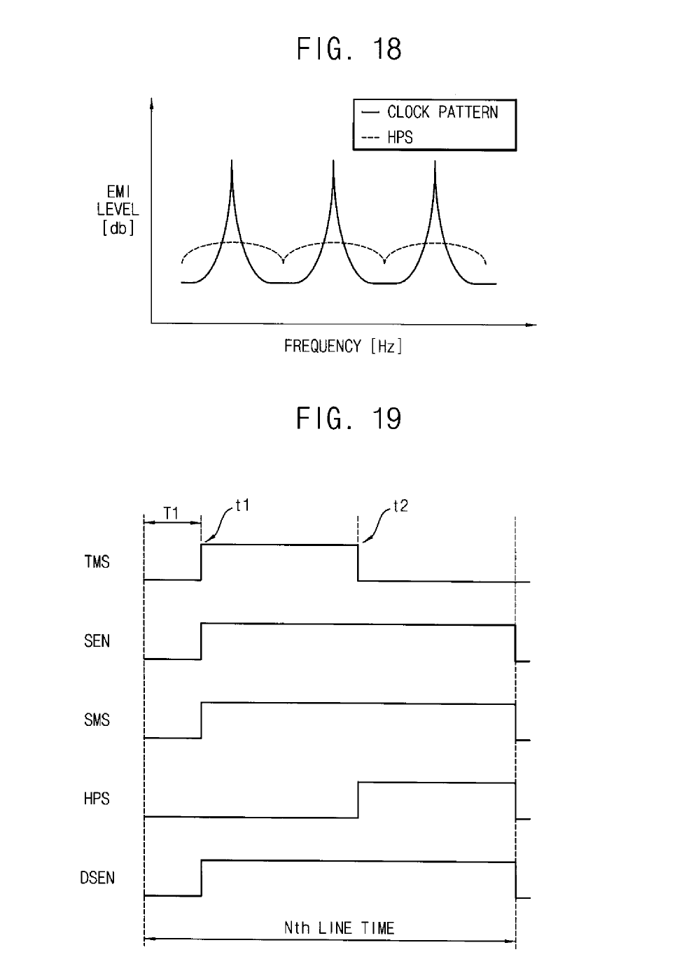

FIG. 19 is a timing diagram illustrating control signals in the data transfer period according to an exemplary embodiment.

Referring to FIGS. 4 through 19, when transmission of the line start field 441a and the configuration field 442a is completed during an interval (T1), transmission of the pixel data field 443a starts at a time (t1). At this time, the transmission mode signal TMS transitions to high level and the multiplexer 123 selects the image data IDTA to be provided to the scrambling unit 124. When the transmission mode signal TMS transitions to high level, the scrambler enable signal SEN transitions to high level and the first scrambler 124a randomizes the image data IDTA to provide the randomized data to the source driver 130. The source driver 130 de-randomizes the image data from the timing controller 120 in response to the descrambler enable signal DSEN. At time (t2), when transmission of the pixel data field 443a is completed, the transmission mode signal TMS transitions to low level and the multiplexer 123 selects the clock pattern to be provided to the scrambling unit 124. The second scrambler 124b applies the scrambling codes to the clock pattern to generate the random data patterns in response to the horizontal blank period control signal HPS having a high level. The random data pattern is transmitted to the source driver 130 and the random data pattern is recovered to the clock pattern in the clock recovery unit 133. The clock recovery unit 133 may perform clock training based on the clock pattern while the data converting unit 137 generates analog voltages by selecting grey voltages based on the digital data from the data latch unit 136 and provides the analog voltages to the display panel 110 via the source line SL.

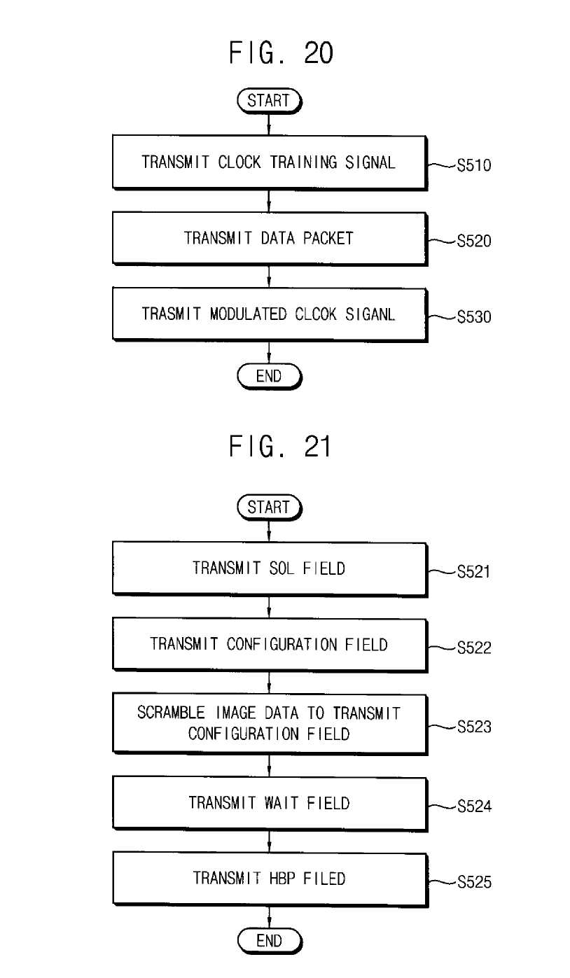

FIG. 20 is a flow chart illustrating a method of transmitting data in a display device of FIG. 1, according to one exemplary embodiment.

Referring to FIGS. 1, 4 through 10, the timing controller 120 may transmit clock training signals to the source drivers 130, 140 and 150 such that the clock recovery unit 133 becomes locked in an initialization period (S510). For example, the timing controller 120 may transmit the clock training signal when a display device 10 is powered on or when a soft fail occurs in the source drivers 130, 140 and 150. The source drivers 130, 140 and 150 may be stabilized in the initial training mode. For example, in the initial training mode, the clock recovery unit 133 included in each source driver 130, 140 and 150 may be locked in response to the clock training signal, and setting values of the source drivers may be initialized.

The timing controller 120 transmits data packets respectively corresponding to lines of an image frame to the source drivers 130, 140 and 150 (S520). The data packets may include data bits and clock codes periodically inserted into the data bits. The clock recovery unit 133 in each source driver 130, 140 and 150 may generate a recovered clock signal by detecting an edge between each clock code and a data bit adjacent to the clock code. The source drivers 130, 140 and 150 may sample the data bits based on the recovered clock signal, and may drive a display panel 110 based on the sampled data bits. As described above, the timing controller 120 scrambles the image data to be written in the pixel data field 443 and inserts the control signal DSEN and SMS indicating that the image data is scrambled in the configuration field 442 and transmits the data packet to the source driver 130 in the data transfer period. In addition, the timing controller 120 scrambles the clock pattern to generate the random data pattern, inserts the random data pattern in the horizontal blank period 445 and transmits the data packet to the source driver 130 in the data transfer period.

The timing controller 120 transmits a modulated clock signal to the source drivers 130, 140 and 150 in a vertical blank period (S530). The modulated clock signal may be generated by adjusting at least one of a rising edge and a falling edge of the clock training signal. In some embodiments, in the vertical training mode, the timing controller 120 may transmit the clock training signal without the modulation during a predetermined time before the display data mode starts.

The transfer of the data packets and the transfer of the modulated clock signal may be repeatedly performed per image frame. If the source drivers 130, 140 and 150 are unlocked (e.g., by a soft fail) during the transmission of the data packet and the modulated clock signal, the source drivers 130, 140 and 150 may provide the timing controller 120 with soft fail information. When the timing controller 120 receives the soft fail information from the source drivers 130, 140 and 150, the timing controller may transmit the clock training signal again to all of source drivers 130, 140 and 150 or some of the source drivers 130, 140 and 150 in which the soft fail occurs.

FIG. 21 is a flow chart illustrating a step of transmitting a data packet in FIG. 20 according to an exemplary embodiment.

Referring to FIGS. 1 through 21, the timing controller 120 transmits the line start field 441a indicating a start of each line of an image frame to the source driver 130 in the data transfer period (S521). When transmission of the line start field 441a is completed, the timing controller 120 transmits the configuration field 442a that includes configuration data for controlling the source driver 130 to the source driver 130 (S522). The configuration data written in the configuration field 442a may include the scrambling mode signal SMS and the descrambler enable signal DSEN. In addition, the configuration data written in the configuration field 442a may include the horizontal blank period control signal HPS.

When transmission of the configuration field 442a is completed, the timing controller 120 transmits the pixel data field 443a that includes the scrambled image data to the source driver 130 (S523). As described above, the image data IDTA is randomized to the scrambled image data using the multi-bit scrambling code or the single-bit scrambling code according to the state of the image data IDTA. When transmission of the pixel data field 443a is completed, the timing controller 120 transmits the wait field 444a which is assigned for the source driver 130 to have a first time to receive and to store the image data IDTA (S524). After the source driver 130 receives the randomized imaged data, the source driver 130 may de-randomized the randomized image data. When transmission of the wait data field 444a is completed, the timing controller 120 transmits the horizontal blank field 445a, which is assigned for the source driver 130 to have a second time to drive the display panel 110 based on the image data IDTA (S525). In one embodiment, the horizontal blank field 445a may include one of the clock pattern C_PAT in FIG. 13 and the random data patterns HPS_PAT#1, HPS_PAT#2, HPS_PAT#3 and HPS_PAT#4 in FIG. 14 that the scrambling code is applied to the clock pattern C_PAT.

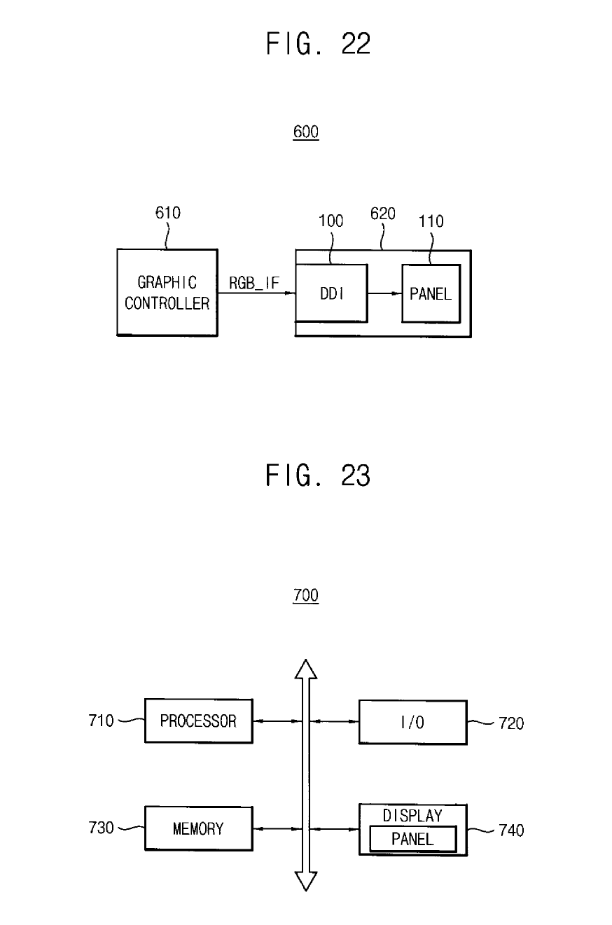

FIG. 22 is a display system including the display device of FIG. 1 according to an exemplary embodiment.

Referring to FIG. 22, a display system 600 may include a graphic controller 610 and a display device 620. The graphic controller 610 may provide the display device 620 with RGB interface signals RGB_IF including control signals and image data. The control signals included in the RGB interface signals RGB_IF may include a vertical sync signal VSYNC, a horizontal sync signal HSYNC, and a data enable signal DE. The display device 620 may include the display driver circuit 100 and the display panel 110. The display panel 110 may include a plurality of pixels displaying an image. The pixels may be formed at intersections of gate lines and source lines respectively. The display driver circuit 100 may include the timing controller 120 and the source drivers 130, 140 and 150. As described with reference to FIGS. 1 through 19, in some embodiments, the timing controller 120 randomizes the imaged data in the scrambling mode according to the data of the image data. The timing controller 120 may also scramble the clock pattern to the random data pattern. The randomized data and in one embodiment the random data pattern are transmitted to the source drivers 130, 140 and 150 in the data transfer period, thereby reducing EMI in the channels CH1, CH2 and CH3.

FIG. 23 is a block diagram illustrating an electronic device including the display device of FIG. 1 according to an exemplary embodiment.

Referring to FIG. 23, an electronic device 700 may include a processor 710, a memory device 730, an input/output (I/O) device 720, and a display device 740.

The processor 710 may perform specific calculations, or computing functions for various tasks. For example, the processor 710 may correspond to a microprocessor, a central processing unit (CPU), etc. The processor 710 may be coupled to the memory device 730 via a bus. For example, the memory device 730 may include at least one volatile memory device such as a dynamic random access memory (DRAM) device, a static random access memory (SRAM) device, etc. and/or at least one non-volatile memory device such as an erasable programmable read-only memory (EPROM) device, an EEPROM device, a flash memory device, etc. The memory device 730 may store software performed by the processor 710. The I/O device 720 may be coupled to the bus. The I/O device 720 may include at least one input device (e.g., a keyboard, keypad, a mouse, etc.), and/or at least one output device (e.g., a printer, a speaker, etc.). The processor 810 may control operations of the I/O device 720.

The display device 740 may be coupled to the processor 710 via the bus. The display device 740 may include the display driver circuit 100 and the display panel 110. The display panel 110 may include the pixels that are coupled to the gate lines and the source lines. The display driver circuit 100 may include the timing controller 120 and the source drivers 130, 140 and 150. As described with reference to FIGS. 1 through 19, in certain embodiments, the timing controller 120 randomizes the image data in the scrambling mode according to the data of the image data. The timing controller 120 may additionally scramble the clock pattern to the random data pattern, and may transmit the randomized data and in one embodiment the random data pattern to the source drivers 130, 140 and 150 in the data transfer period, thereby reducing EMI in the channels CH1, CH2 and CH3.

The electronic device 700 may correspond, for example, to a digital television, a cellular phone, a smart phone, a personal digital assistant (PDA), a portable multimedia player (PMP), an MP3 player, a laptop computer, a desktop computer, a digital camera, etc.

As mentioned above, according to certain exemplary embodiments, the image data is randomized in the scrambling mode according to the data of the image data, the clock pattern is scrambled to the random data pattern and the randomized data and the random data pattern are transmitted to the source drivers in the data transfer period, thereby reducing EMI in the channels.

The present embodiments may be applied to various fields requiring display devices.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present inventive concept as defined in the claims.

What is claimed is:

1. A display driver circuit comprising:
a source driver configured to drive source lines of a display panel; and
a timing controller configured to transmit image data to the source driver and configured to control the source driver such that the transmitted image data is displayed in the display panel,
the timing controller configured to randomize the image data in a scrambling mode when the timing controller transmits data packets including a pixel data field in which the image data is written.

2. The display driver circuit of claim 1, wherein the timing controller includes a scrambler configured to randomize the image data and the scrambler is configured to randomize the image data by generating a single-bit scrambling code or a multi-bit scrambling code.

3. The display driver circuit of claim 2, wherein the single-bit scrambling code includes a single bit used to scramble each bit of the image data, and the multi-bit scrambling code includes a plurality of scrambling bits, each scrambling bit used to scramble a respective bit of the image data.

4. The display driver circuit of claim 2, wherein the source driver includes a de-scrambler configured to de-randomize the transferred image data, and the de-scrambler is configured to de-randomize the transmitted image data by receiving a scrambling mode signal and a de-scrambler enable signal that enables the de-scrambler from the timing controller, the scrambling mode signal indicating whether the image data is randomized using the single-bit scrambling code or the multi-bit scrambling code.

5. The display driver circuit of claim 4, wherein the data packet further includes a configuration field for controlling the source driver, and the de-scrambler enable signal and the scrambling mode signal are written in the configuration field and are transmitted from the timing controller to the source driver.

6. The display driver circuit of claim 1, wherein the timing controller writes random data pattern in a horizontal blank field and transmits the horizontal blank field to the source driver when the timing controller transmits the horizontal blank field which is assigned for the source driver to have a time to drive the display panel, the random data pattern is generated by applying a scrambling code to a clock pattern.

7. The display driver circuit of claim 6, wherein the timing controller comprises:
a pattern generator configured to generate the clock pattern; and
a scrambler configured to generate the random data pattern based on the clock pattern.

8. The display driver circuit of claim 6, wherein the source driver receives a horizontal blank field control signal to de-randomize the random data pattern, the horizontal blank field control signal indicating that the scrambling code is applied to data pattern written in the horizontal blank field.

9. The display driver circuit of claim 8, wherein the data packet further includes a configuration field for controlling the source driver, and the horizontal blank field control signal is written in the configuration field, which is transferred from the timing controller to the source driver.

10. The display driver circuit of claim 1, further comprising:
an additional source driver configured to drive additional source lines of a display panel, wherein:
the timing controller is configured to randomize image data for the additional source driver and send the randomized image data over a separate channel to the second source driver.

11. A method of transferring data in a display driver circuit, the method comprising:
transmitting a configuration field from a timing controller to a source driver, configuration data for controlling the source driver being written in the configuration field;
transmitting, from the timing controller to the source driver, a pixel data field in which image data is written;
transmitting, from the timing controller to the source driver, a waiting field which is assigned for the source driver to have a first time to receive and to store the image data; and
transmitting, from the timing controller to the source driver, a horizontal blank field which is assigned for the source driver to drive a display panel based on the image data,
the timing controller configured to randomize the image data in a scrambling mode and to transmit the scrambled image data to the source driver.

12. The method of claim 11, further comprising:
de-randomizing the scrambled image data in the source driver.

13. The method of claim 11, further comprising randomizing the image data by generating a single-bit scrambling code or a multi-bit scrambling code.

14. The method of claim 13, wherein the timing controller inserts a scrambling mode signal in the configuration field and transmits the configuration field to the source driver and the source driver de-randomizes the transmitted image data in response to the scrambling mode signal, the scrambling mode signal indicating whether the image data is randomized to the single-bit scrambling code or the multi-bit scrambling code.

15. The method of claim 11, wherein the timing controller writes random data pattern that a scrambling code is applied to a clock pattern in a horizontal blank field and transmits the horizontal blank field to the source driver when the timing controller transmits the horizontal blank field which is assigned for the source driver go have a time to drive the display panel.

16. The method of claim 15, wherein the random data pattern is one of a plurality of random data patterns that are generated by applying the scrambling to the clock pattern.

17. The method of claim 15, wherein the timing controller inserts a horizontal blank field control signal in the configuration field and transmits the configuration field to the source driver, the horizontal blank field control signal indicating that the scrambling code is applied to data pattern written in the horizontal blank field.

18. A display driver circuit, comprising:
a timing controller configured to transmit first scrambled image data to a first channel, and to transmit second scrambled image data to a second channel;
a plurality of source drivers coupled to the timing controller and configured to receive scrambled image data from the timing controller via a respective channel;
a first source driver of the plurality of source drivers, the first source driver coupled to the first channel and configured to receive the first scrambled image data and de-scramble the image data; and
a second source driver of the plurality of source drivers, the second source driver coupled to the second channel and configured to receive the second scrambled image data and de-scramble the image data.

19. The display driver circuit of claim 18, wherein the first source driver includes a de-scrambler configured to unscramble the transmitted scrambled image data, and the de-scrambler is configured to unscramble the image data by receiving, from the timing controller, a scrambling mode signal and a de-scrambler enable signal that enables the de-scrambler, the scrambling mode signal indicating whether the image data is randomized using a single-bit scrambling code or a multi-bit scrambling code.

20. The display circuit of claim 19, wherein:
the scrambled data is sent using data packets, and each data packet further includes a configuration field for controlling the source driver, and
the de-scrambler enable signal and the scrambling mode signal are written in the configuration field and are transmitted from the timing controller to the source driver.
